(19) United States
(12) Patent Application Publication
(10) Pub. No.: US 2016/0144726 A1
(43) Pub. Date: May 26, 2016

(54) VEHICULAR WIRELESS POWER FEEDING SYSTEM, VEHICLE-SIDE POWER FEEDING SYSTEM AND PORTABLE APPARATUS

(71) Applicant: DENSO CORPORATION, Kariya-city, Aichi-pref (JP)

(72) Inventors: Ichiro YOSHIDA, Kariya-city (JP); Kiyohiko SAWADA, Kariya-city (JP)

(21) Appl. No.: 14/900,572

(22) PCT Filed: Jun. 17, 2014
(86) PCT No.: PCT/JP2014/003217

§ 371 Date: Dec. 21, 2015

(30) Foreign Application Priority Data
Jun. 25, 2013 (JP) 2013-132626

(51) Int. Cl. B60L 11/18; H02J 7/00

(52) U.S. Cl. CPC B60L 11/182; B60L 11/1861; H02J 7/0047; H02J 2007/005

(57) ABSTRACT

A vehicular wireless power feeding system includes a portable apparatus, a vehicle-side wireless power feeding system and a notifier. The portable apparatus operates using power, which is stored in an attached battery. The vehicle-side wireless power feeding system has a wireless power feeder arranged in the vehicle and for wirelessly feeding power to a wireless power receiver of the portable apparatus. The notifier notifies of, as wireless power feeding information, information related to wireless power feeding from the wireless power feeder to the wireless power receiver.

### CROSS REFERENCE TO RELATED APPLICATION

This application is based on Japanese Patent Application No. 2013-132626 filed on Jun. 25, 2013, the disclosure of which is incorporated herein by reference.

### TECHNICAL FIELD

The present disclosure relates to a vehicular wireless power feeding system to be adapted to a vehicle compartment, a vehicle-side power wireless power feeding system to be installed in a vehicle, and a portable apparatus to which power is wirelessly fed from the vehicle-side wireless power feeding system.

### BACKGROUND ART

A wireless power feeding system that wirelessly transmits (feeds) power from a power feeding device to a power receiving device has been provided (refer to, for example, Patent Literature 1).

### PRIOR ART LITERATURES

### Patent Literature

Patent Literature 1: JP 2011-514781-A

### SUMMARY OF INVENTION

In recent years, portable apparatuses including, for example, a smartphone have widely prevailed. This type of portable apparatus operates using power, which is accumulated in a battery (for example, a lithium ion battery), as operating power. In this case, the capacity of the battery to be incorporated in the portable apparatus has a limitation due to a restriction imposed on the size or weight of the portable apparatus. Sophistication of onboard devices including, for example, a vehicle navigation device makes it possible to provide various applications through linkage between the portable apparatus, which a user has carried into a vehicle compartment with him/her, and the onboard device. For example, an application that allows music data, which is preserved in the portable apparatus, to be transferred from the portable apparatus to the onboard device, and allows the transferred music data to be outputted through a loudspeaker accompanying the onboard device can be provided.

Under the circumstances, the portable apparatus is requested to preserve operating power to a certain extent even when having been carried into a vehicle compartment. As one of schemes in which the portable apparatus preserves the operating power all the time in the vehicle compartment, a power feeding device that wirelessly feeds power is presumably mounted in a vehicle in order to wirelessly feed power from the power feeding facility to the portable apparatus. However, assuming that power is wirelessly fed to the portable apparatus having been carried into the vehicle compartment, a mechanism for providing a user with various pieces of information concerning wireless power feeding, such as, where is a position at which power can be wirelessly fed, whether wireless power feeding is under way, or to what extent power has been wirelessly fed is desired.

The present disclosure addresses the foregoing circumstances. An object of the present disclosure is to provide a vehicular wireless power feeding system that provides a user with various pieces of information concerning wireless power feeding when power is wirelessly fed to a portable apparatus carried into a vehicle compartment, and thus contributes to improvement of convenience, a vehicle-side wireless power feeding system, and a portable apparatus.

According to a vehicular wireless power feeding system in accordance with an aspect of the present disclosure, a portable apparatus includes a battery and operates using power, which is accumulated in the battery, as operating power. A vehicle-side wireless power feeding system installed in a vehicle includes a wireless power feeding means that wirelessly feeds power to a wireless power receiving means of the portable apparatus. A notifier posts, as wireless power feeding information, information concerning wireless power feeding to be made from the wireless power feeding means to the wireless power receiving means. Accordingly, various pieces of information concerning wireless power feeding to be made from the wireless power feeding means to the wireless power receiving means can be presented to a user, and convenience can be improved. What are referred to as various pieces of information concerning wireless power feeding are pieces of information on, for example, where is a position at which power can be wirelessly fed, whether wireless power feeding is in progress, and to what extent power has been wirelessly fed.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram showing an embodiment of the present disclosure;

FIG. 2 is a diagram showing a situation in which power feeding cases are disposed in a vehicle compartment;

FIG. 3 is a front view of a lid member inclusive power feeding case;

FIG. 4 is a longitudinal-section side view of the lid member inclusive power feeding case;

FIG. 5 is a diagram showing a situation in which lid member inclusive power feeding cases are disposed on an internal flank of a door;

FIG. 6 is a perspective view of a locking power feeding case;

FIG. 7 is a longitudinal-section side view of the locking power feeding case;

FIG. 8 is a sequence chart (part 1);

FIG. 9 is a sequence chart (part 2);

FIG. 10 is a sequence chart (part 3);

FIG. 11 is a sequence chart (part 4);

FIG. 12 is a diagram showing a display screen of a portable apparatus (part 1);

FIG. 13 is a diagram showing the display screen of the portable apparatus (part 2);

FIG. 14 is a diagram showing the display screen of the portable apparatus (part 3);

FIG. 15 is a diagram showing the display screen of the portable apparatus (part 4); and

FIG. 16 is a diagram showing the display screen of the portable apparatus (part 5).

### EMBODIMENTS FOR CARRYING OUT INVENTION

Referring to the drawings, an embodiment of the present disclosure will be described below. A vehicular wireless power feeding system 1 includes a vehicle-side wireless power feeding system 2 installed in a vehicle, and a portable apparatus 3 which a user can carry into a vehicle compartment with him/her. Who is referred to as the user is a driver who drives a vehicle or an occupant. What is referred to as the portable apparatus 3 is a device which the driver or occupant carries with him/her and manipulates, for example, a smartphone or portable cellular phone.

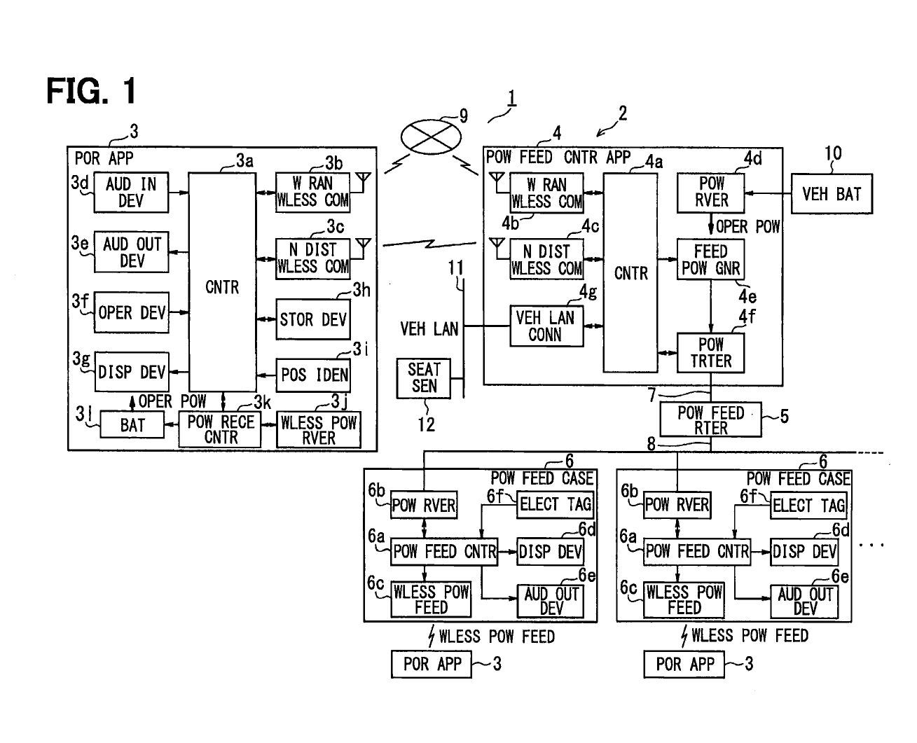

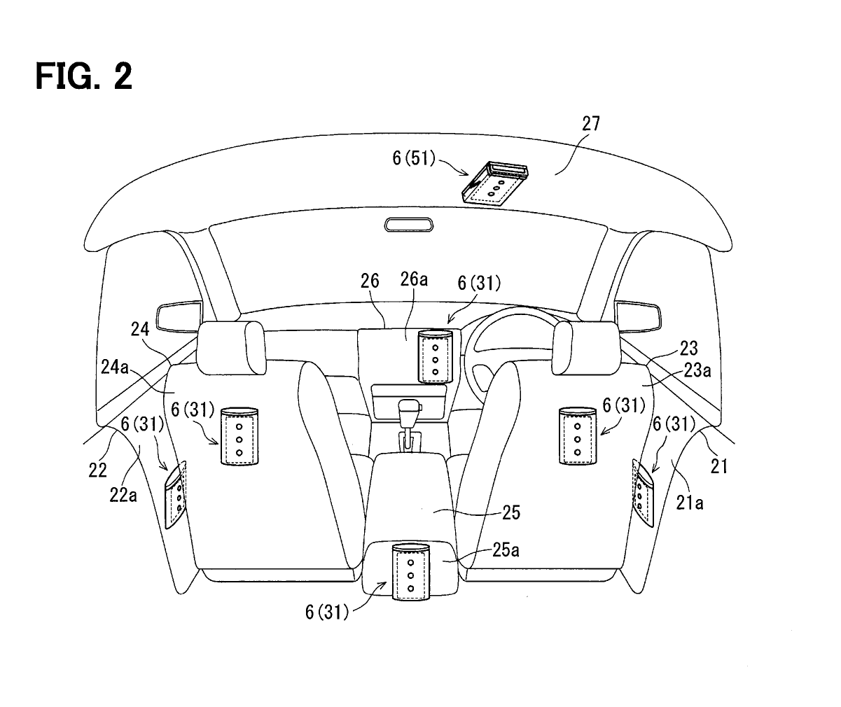

The vehicle-side wireless power feeding system 2 includes a power feeding control apparatus 4 and plural power feeding cases 6 connected to the power feeding control apparatus 4 via a power feeding router 5. The power feeding control apparatus 4 and power feeding router 5 are interconnected over a power feeding cable 7. The power feeding router 5 and power feeding cases 6 are interconnected over a power feeding cable 8. The power feeding cases 6 are cases each of which, as described later, accommodates a portable apparatus 3 so as to wirelessly feed power to the portable apparatus 3. The power feeding cases 6 have to be mounted in a vehicle component (within reach of a user) so that a user can readily stow the portable apparatus 3 in any of the power feeding cases. In contrast, the power feeding control apparatus 4 and power feeding router 5 need not be mounted in the vehicle compartment as long as they are incorporated in the vehicle. FIG. 1 shows one power feeding router 5. Alternatively, plural power feeding routers may be included. FIG. 1 shows two power feeding cases 6. Alternatively, the number of power feeding cases may be one, or three or more power feeding cases may be included as shown in FIG. 2 to be referred to later. The power feeding cables 7 and 8 may be embedded in a vehicle body in consideration of convenience, which should be ensured to help a user ride in or alight from the vehicle, or aesthetic preference.

The power feeding control apparatus 4 includes a controller 4a, wide range wireless communicator 4b, short distance wireless communicator 4c, power receiver 4d, feeding power generator 4e, power transmitter 4f, vehicle local area network (LAN) connector 4g. The controller 4a is realized with a known microcomputer including a central processing unit (CPU), read-only memory (ROM), random access memory (RAM), and input/output bus. A computer program stored in the ROM or the like is run in order to control all activities of the power feeding control apparatus 4 including communication and power transmission.

The wide range wireless communicator 4b performs wide area wireless communication over a wide area wireless communication network 9 including a moving entity telephone network. The near distance wireless communicator 4c performs near distance wireless communication according to Bluetooth (registered trademark), WiFi (registered trademark), or any other wireless communications protocol for wireless local area networks (LAN). As the communications protocol for wireless LANs, for example, the IEEE 802.11b standard that defines wireless communication to be performed at 11 Mbps within a band of 2.4 GHz and that is stipulated by the Institute of Electrical and Electronics Engineers (IEEE) may be adopted. In this case, the near distance wireless communicator 4c performs near distance wireless communication with a near distance wireless communicator 3c of the portable apparatus 3 under such conditions that the portable apparatus 3 to be described later has been carried into a vehicle compartment and the portable apparatus 3 having been carried into the vehicle compartment exists within a communication zone for near distance wireless communication.

The power receiver 4d converts power of a predetermined voltage, which is transmitted from the vehicle battery 10 mounted in a vehicle, into another voltage, and feeds the power, which has its voltage converted, as operating power to functional blocks. The feeding power generator 4e produces feed power, which the power feeding case 6 to be described later wirelessly feeds to the portable apparatus 3, and transmits the produced feed power to the power transmitter 4f. The power transmitter 4f receives the feed power which is transmitted from the feeding power generator 4e, and in turn transmits the received feed power to the power feeding router 5 over the power feeding cable 7. The vehicle LAN connector 4g is connected to seating sensors 12, which are disposed at a driver seat, passenger seat, and rear sheet respectively, over a vehicle LAN 11. When a user is seated, any of the seating sensors 12 outputs a seating sense signal, which signifies that the user has been seated, to the vehicle LAN connector 4g over the vehicle LAN 11.

The power feeding router 5 receives feed power, which is transmitted from the power transmitter 4f of the power feeding control apparatus 4, over the power feeding cable 7, and in turn transmits the received feed power to the power feeding case 6 over the power feeding cable 8.

The power feeding cases 6 are cases that can accommodate the portable apparatus 3 and wirelessly feed power to the accommodating portable apparatus 3. The power feeding cases 6 are, as shown in FIG. 2, disposed, for example, on an internal flank 21a of a driver seat door 21, an internal flank 22a of a passenger seat door 22, a back surface 23a of the driver seat 23, a back surface 24a of a passenger seat 24, a back surface 25a of a center console 25, a face 26a of an instrument panel 36, and a ceiling 27 of a vehicle compartment above the driver seat. Namely, the power feeding cases 6 are disposed within reach of a driver seated on the driver seat, an occupant seated on the passenger seat, or an occupant seated on the rear seat. The power feeding cases 6 may be disposed on regions other than the regions shown in FIG. 2.

Each of the power feeding cases 6 includes a power feeding controller 6a, power receiver 6b, wireless power feeder 6c (wireless power feeding means), display device 6d (notifier), audio output device 6e (notifier), and electronic tag 6f. The power feeding controller 6a is realized with a known microcomputer including a CPU, ROM, RAM, and input/output bus, runs a computer program stored in the ROM or the like, and controls all activities of the power feeding case 6 including power receiving, wireless power feeding, indication, and audio output.

The power receiver 6b receives feed power, which is transmitted from the power feeding router 5, over the power feeding cable 8. The wireless power feeder 6c includes a power feeding coil (not shown) and power feeding capacitor (not shown), induces a magnetic field and resonates together with a power receiving coil (not shown) and power receiving capacitor (not shown) of the wireless power receiver 3j of the portable apparatus 3 which will be described later, and thus wirelessly feeds (transmits) power to the portable apparatus 3. The power feeding controller 6a outputs a wireless power feeding control instruction to the wireless power feeder 6c under a condition that contactless communication with the electronic tag 6f has been established, and controls wireless power feeding to be made from the wireless power feeder 6c to the wireless power receiver 3j of the portable apparatus 3. In this case, the power feeding controller 6a can control an amount of power to be fed from the wireless power feeder 6c.

The power feeding controller 6a outputs an indication instruction to the display device 6d, and allows the display block 6d to indicate, as wireless power feeding information, information concerning wireless power feeding to be made from the wireless power feeder 6 to the wireless power receiver 3j. The power feeding controller 6a outputs an audio output instruction to the audio output device 6e, and allows the display device 6d to indicate as the wireless power feeding information the information concerning wireless power feeding to be made from the wireless power feeder 6 to the wireless power receiver 3j. What is referred to as the wireless power feeding information is information on whether wireless power feeding can be performed, information on an amount of wirelessly fed power, information on a charged capacity of a battery 31 of the portable apparatus 3 which will be described later, or information on whether wireless power feeding is normal. The present embodiment employs, as mentioned above, a magnetic field resonance method that wirelessly feeds power by utilizing magnetic field resonance. Alternatively, a radio wave method that wirelessly feeds power in the form of electromagnetic waves, an electromagnetic induction method that wirelessly feeds power with an induction magnetic flux as a medium, or an electric field coupling method that wirelessly feeds power by utilizing an electric field will do. The power feeding control apparatus 4 and power feeding case 6 can perform power line communication (PLC) between them. A scheme for data communication is, for example, the orthogonal frequency division multiplexing (OFDM) method.

The portable apparatus 3 includes a controller 3a, wide range wireless communicator 3b, near distance wireless communicator 3c, audio input device 3d, audio output device 3e, operating device 3f, display device 3g (notifier), storage device 3h, position identifier 3i, wireless power receiver 3j (wireless power receiving means), power receiving controller 3k, and battery 3l. The controller 3a is realized with a known microcomputer including a CPU, ROM, RAM, and input/output bus, runs a computer program stored in the ROM or the like, and controls all activities of the portable apparatus 3 including communication, voice speech, data management, wireless power feeding, display, and audio output.

The wide range wireless communicator 3b performs wide area wireless communication over the wide area wireless communication network 9. The near distance wireless communicator 3c performs near distance wireless communication according to Bluetooth (registered trademark), WiFi (registered trademark), or any other wireless communications protocol for wireless LANs. The near distance wireless communicator 3c performs near distance wireless communication with the near distance wireless communicator 4c of the power feeding control apparatus 4 under such conditions that the portable apparatus 3 has been carried into a vehicle compartment and the portable apparatus having been carried into the vehicle compartment exists within a communication zone for near distance wireless communication.

The audio input device 3d externally inputs sounds. The audio output device 3e externally outputs sounds. When voice speech to be realized by a voice speech feature of the portable apparatus 3 is under way, if the controller 3a receives voice, which is uttered by a user, by means of the audio input device 3d, the controller 3a allows the wide range wireless communicator 3b to transmit the inputted voice as outgoing voice to the other party. If the controller 3a receives voice, which is transmitted from the other party, by means of the wide range wireless communicator 3b, the controller 3a allows the audio output block 3c to output the received voice as incoming voice. The operating device 3f includes mechanical keys arranged on the body of the portable apparatus 3 and touch keys displayed on the display device 3g. When a user manipulates a key, the operating block 3g outputs a manipulation signal, which signifies the manipulation, to the controller 3a. The display device 3g inputs a display instruction from the controller 3a, and in turn displays a display screen image associated with the inputted display instruction. The position identifier 3i includes, for example, a global positioning system (GPS) receiver and identifies the position of the portable apparatus 3.

The wireless power receiver 3j rectifies a high-frequency current, which is generated because the wireless power receiver induces a magnetic field and resonates together with the wireless power feeder 6c of the power feeding case 6, produces a direct current, converts the produced direct current into power, and outputs the power to the power receiving controller 3k. The power receiving controller 3k inputs the power from the wireless power receiver 3j, and in turn outputs the inputted power to the battery 3l. The battery 3l is, for example, a lithium ion battery and is detachably attached to the body of the portable apparatus. The battery 3l feeds the accumulated power as operating power to the functional blocks. If the battery 3l inputs power from the power receiving controller 3k, the battery 3l is charged with the inputted power (additionally charged).

Next, the power feeding case 6 will be described below. The power feeding case 6 falls into a lid member inclusive power feeding case 31 and locking power feeding case 51 in terms of the shape.

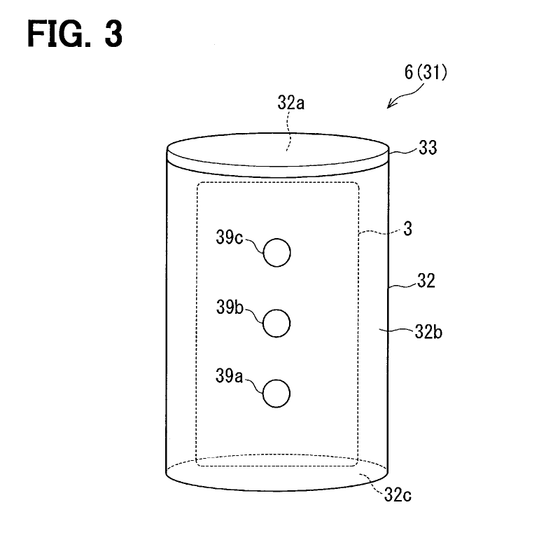

The lid member inclusive power feeding case 31 has, as shown in FIG. 3, a shape that lengthwise accommodates the portable apparatus 3, and is disposed on, for example, the internal flank 21a of the driver seat door 21, the internal flank 22a of the passenger seat door 22, the back surface 23a of the driver seat 23, the back surface 24a of the passenger seat 24, the back surface 25a of the center console 25, or the face 26a of the instrument panel 26.

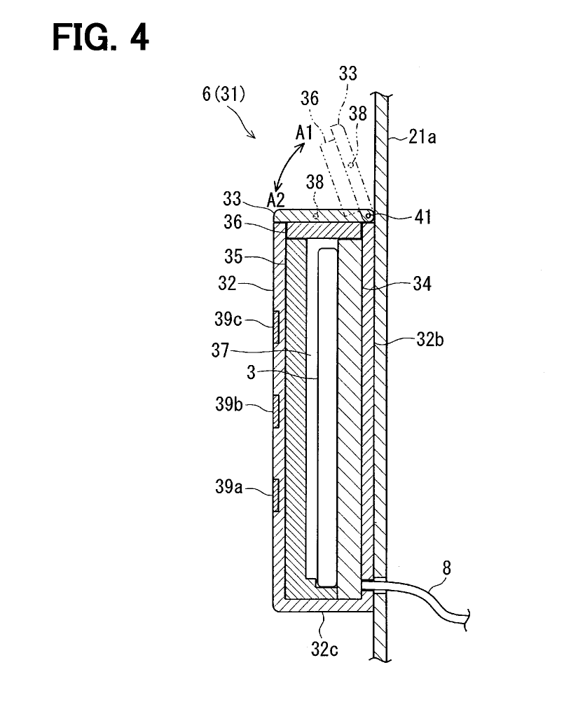

The lid member inclusive power feeding case 31 has, as shown in FIG. 4, a case body 32 and a lid member 33 that is reciprocated or turned (in directions of arrows A1 and A2) on a turning pivot 41, which serves as a turning center, between an open position and closed position with respect to the case body 32. The lid member 33 brings an opening 32a of the case body 32 to an open state when being set to the open position, and brings the opening 32a of the case body 32 to a closed state when being set to the closed position. The case body 32 has an elliptical cross section and includes a trunk 32b, which forms curved surfaces, and a bottom 32c. The lid member inclusive power feeding case 31 is attached so that the external side of the back surface of the trunk 32b can be opposed to the internal flank of a door or the back surface of a seat (in FIG. 4, for example, the internal flank 21a of the driver seat door 21). A wireless power feeding circuit unit 34 is disposed on the internal side of the back surface of the trunk 32b. The power feeding controller 6a, power receiver 6b, wireless power feeder 6c (including the power feeding coil and power feeding capacitor) are incorporated in the wireless power feeding circuit unit 34, and the power feeding cable 8 is coupled to the wireless power feeding circuit unit 34. Feed power transmitted from the power feeding router 5 is received by the wireless power feeding circuit unit 34 over the power feeding cable 8.

A shielding member 35 for shielding electromagnetic waves is disposed on a region covering the internal side of the face of the trunk 32b, the internal sides of the flanks of the trunk 32b, and the internal side of the bottom. Further, a shielding member 36 is disposed on the lower surface of the lid member 33. In the case body 32, a gap between the wireless power feeding circuit unit 34 and shielding member 35 serves as a stowage space capable of accommodating the portable apparatus 3. When the portable apparatus 3 is stowed lengthwise in the stowage space 37, the wireless power feeder 6c of the power feeding case 6 and the wireless power receiver 3j of the portable apparatus 3 are opposed to each other. This makes it possible to wirelessly feed power from the wireless power feeder 6c to the wireless power receiver 3j. A chip 38 including the electronic tag 6f is incorporated in the lid member 33. Further, three LEDs 39a to 39c constituting the display device 6d are arranged on the external side of the face of the trunk 32b.

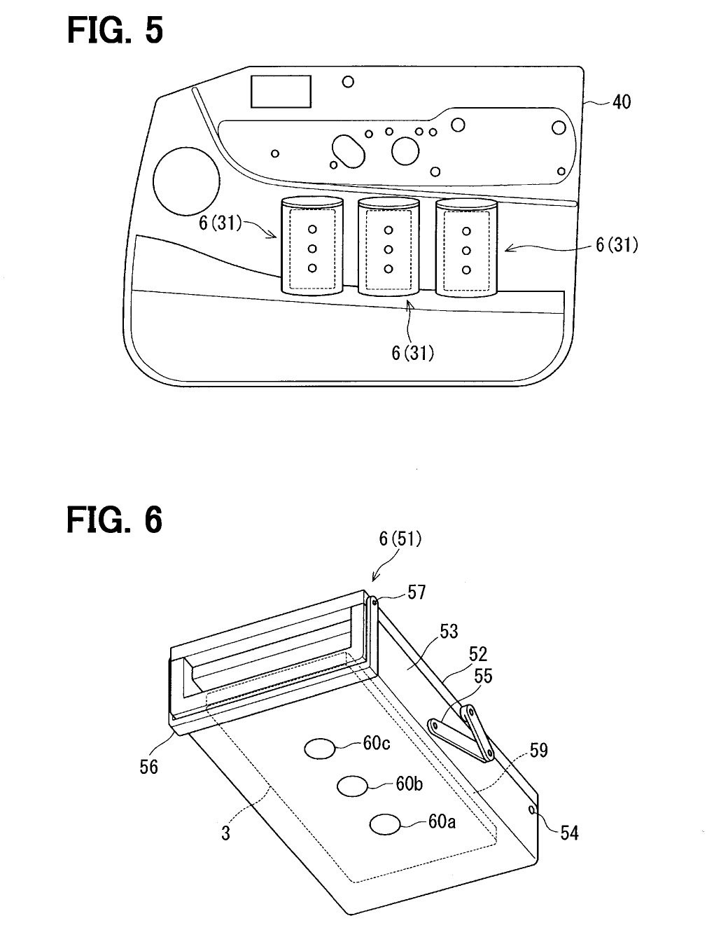

In the forgoing structure, after the portable apparatus 3 is stowed lengthwise in the stowage space 37, when the lid member 33 is moved from the open position to the closed position, contactless communication is established between the power feeding controller 6a and electronic tag 6f. Accordingly, wireless power feeding to be made from the wireless power feeder 6c to the wireless power receiver 3j of the portable apparatus 3 can be initiated. When the lid member 33 has been moved from the open position to the closed position, the portable apparatus 3 is surrounded by the shielding members 35 and 36. Therefore, leakage of electromagnetic waves to outside, which is derived from wireless power feeding, can be hindered by the shielding members 35 and 36. The overall shape of the lid member inclusive power feeding case 31 may be determined in line with the shape of the curved surface of a door or the curved surface of a seat on which the power feeding case is disposed. As shown in FIG. 5, for example, plural lid member inclusive power feeding cases 31 (three cases in FIG. 5) may be disposed on a lining 40 of one door.

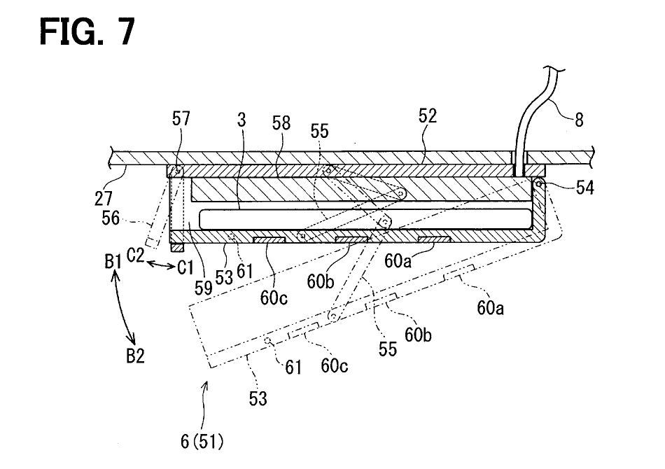

The locking power feeding case 51 has, as shown in FIG. 6, a shape that sideways accommodates the portable apparatus 3, and is disposed on, for example, the ceiling 27 of a vehicle compartment. The locking power feeding case 51 includes, also shown in FIG. 7, a stationary member 52, a movable member 53 that is reciprocated or turned on a turning pivot 54, which serves as a turning center, (in directions of arrows B1 and B2) between a fixed position and an unfixed position with respect to the stationary member 52, a coupling member 55 that couples the stationary member 52 with the movable member 53, and a lock member 56 that is reciprocated or turned on a turning pivot 57, which serves as a turning center, (in directions of arrows C1 and C2) between a locked position and unlocked position with respect to the stationary member 52. The locking power feeding case 51 is attached so that the back surface (upper surface) of the stationary member 52 can be opposed to the ceiling 27 of the vehicle compartment. A wireless power feeding circuit unit 58 is disposed on the face (lower surface) of the stationary member 52. In the wireless power feeding circuit unit 58, similarly to the wireless power feeding circuit unit 34, the power feeding controller 6a, power receiver 6b, and wireless power feeder 6c are incorporated. The power feeding cable 8 is coupled to the wireless power feeding circuit unit 58. Feed power transmitted from the power feeding router 5 is received by the wireless power feeding circuit unit 58 over the power feeding cable 8.

A space below the wireless power feeding circuit unit 58 serves as a stowage space capable of accommodating the portable apparatus 3. When the movable member 53 has been turned to the unfixed position, the stowage space 59 is widely open. The portable apparatus 3 is disposed to be opposed to the wireless power feeding circuit unit 58, the movable member 53 is turned from the unfixed position to the fixed position, and the lock member 56 is turned from the unlocked position to the locked position so that the movable member 53 can be secured at the fixed position. Thus, the portable apparatus 3 is stowed in the stowage space 59 while being secured. When the portable apparatus 3 is sideways stowed in the stowage space 59, the wireless power feeder 6c of the power feeding case 6 and the wireless power receiver 3j of the portable apparatus 3 are opposed to each other. This makes it possible to wirelessly feed power from the wireless power feeder 6c to the wireless power receiver 3j. A chip 61 including the electronic tag 6f is incorporated in the movable member 53. Further, three LEDs 60a to 60c constituting the display device 6d are arranged on the external side of the face of the movable member 53. The locking power feeding case 51 is, similarly to the lid member inclusive power feeding case 31, provided with shielding members (not shown) that shield electromagnetic waves.

In the foregoing structure, the portable apparatus 3 is sideways stowed in the stowage space 59, the movable member 53 is moved from the unfixed position to the fixed position, and the lock member 56 is moved from the unlocked position to the locked position so that the movable member 53 can be secured at the fixed position. In this state, contactless communication is established between the power feeding controller 6a and electronic tag 6f, and wireless power feeding to be made from the wireless power feeder 6c to the wireless power receiver 3j of the portable apparatus 3 can be initiated. The movable member 53 is moved from the unfixed position to the fixed position, the lock member 56 is moved from the unlocked position to the locked position so that the movable member 53 can be secured at the fixed position. In this state, since the portable apparatus 3 is surrounded by the shielding members, leakage of electromagnetic waves to outside, which is derived from wireless power feeding, can be hindered by the shielding members. The overall shape of the locking power feeding case 51 may be determined in line with the shape of the curved surface of, for example, the ceiling on which the locking power feeding case is disposed.

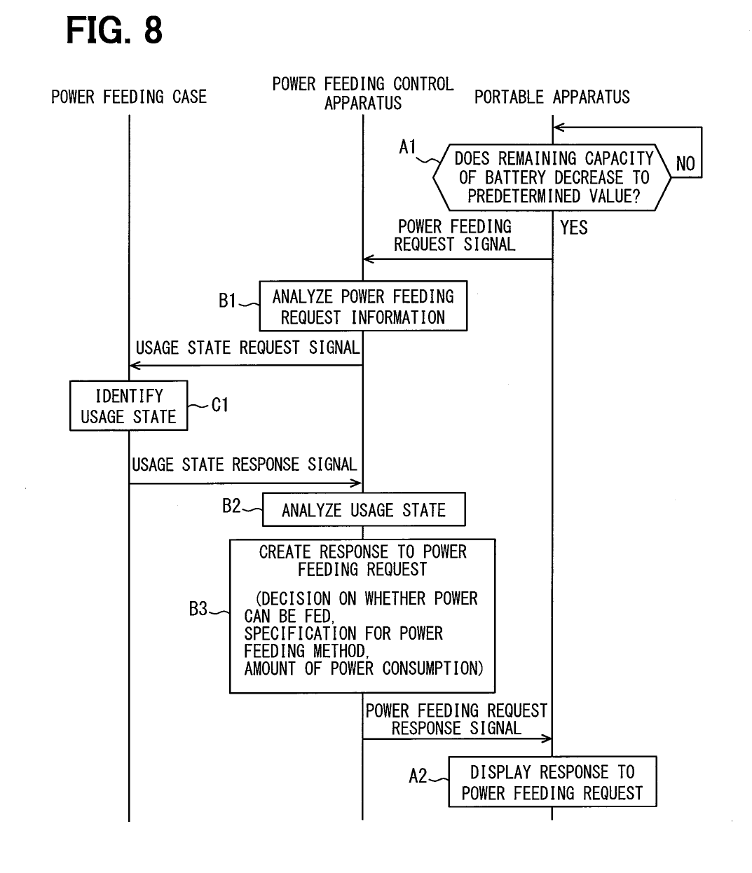

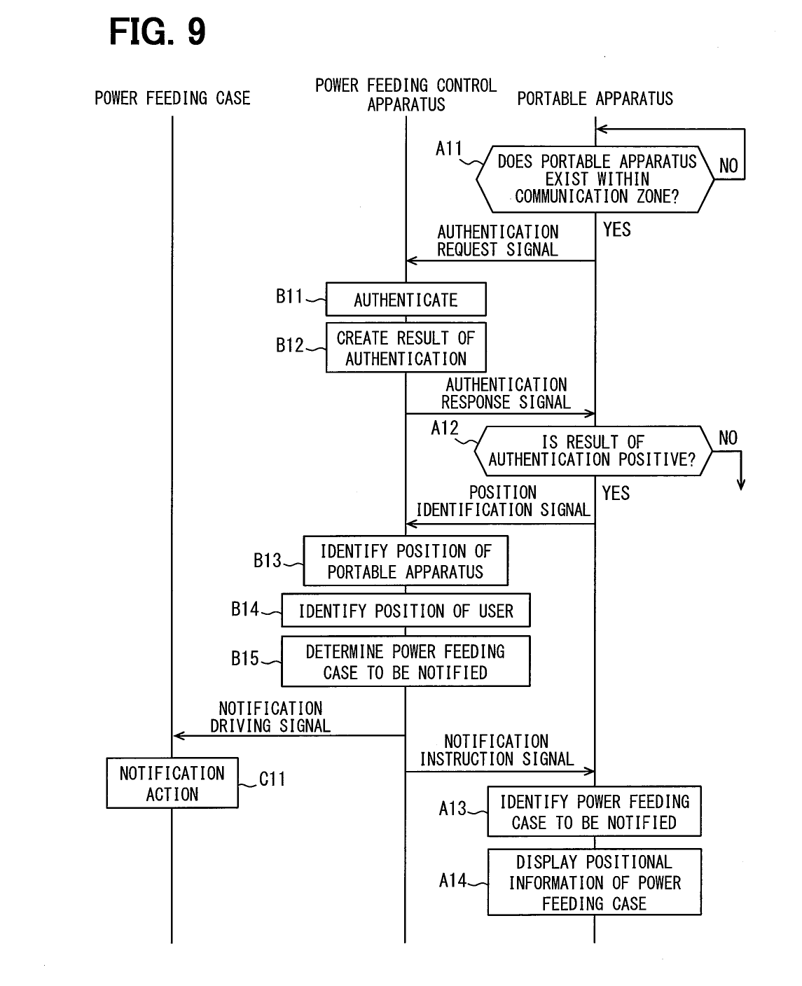

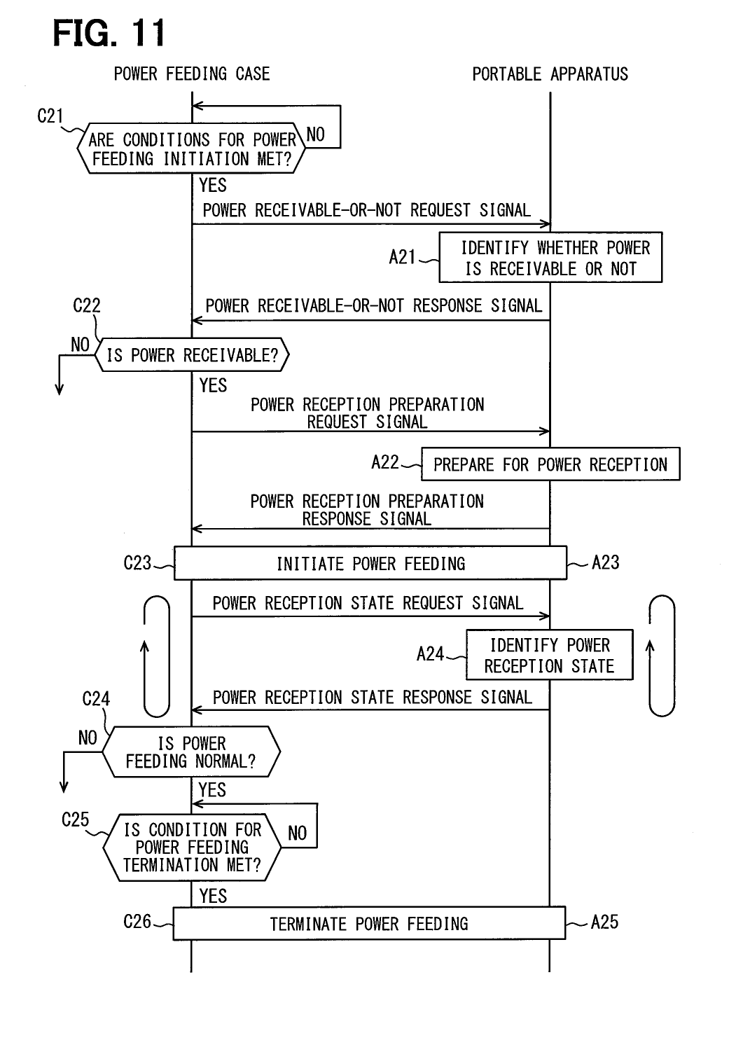

Next, referring to FIG. 8 to FIG. 16, an operation of the aforesaid configuration will be described below. Now, activities to be performed by the power feeding control apparatus 4, power feeding case 6, and portable apparatus 3 will be described below.

(1) Processing of requesting wireless power feeding of the vehicle-side wireless power feeding system 2 to be performed by the portable apparatus 3

(2) Processing of notifying the power feeding case 6, which can wirelessly feed power, to be performed by the vehicle-side wireless power feeding system

(3) Processing of wirelessly feeding power to the portable apparatus 3 to be performed by the power feeding case 6

These pieces of processing will be sequentially described below.

(1) Processing of requesting wireless power feeding of the vehicle-side wireless power feeding system 2 to be performed by the portable apparatus 3

In the portable apparatus 3, the controller 3a regularly monitors the remaining capacity of the battery 31. If the controller 3a decides that the remaining capacity of the battery 31 has decreased to a predetermined value (for example, 20% of a full capacity) (A1: Yes), the controller 3a allows the wide range wireless communicator 3b to transmit a power feeding request signal to the power feeding control apparatus 4 over the wide area communication network 9. In this case, if a user who uses the portable apparatus 3 preliminarily registers information on a transmission destination of the power feeding request signal in the portable apparatus 3, the controller 3a can transmit the power feeding request signal to the power feeding control apparatus 4 which the user has registered in advance. The power feeding request signal to be transmitted from the portable apparatus 3 to the power feeding control apparatus 4 contains power feeding request information that signifies the specifications (wireless power feeding method, resonant frequency, and others) for wireless power feeding of the portable apparatus 3.

In the power feeding control apparatus 4, if the controller 4a receives a power feeding request signal, which is sent from the portable apparatus 3, over the wide area communication network 9 by means of the wide range wireless communicator 4b, the controller 4a extracts power feeding request information from the received power feeding request signal, and analyzes the power feeding request information (B1). Thereafter, the controller 4a allows the power transmitter 4f to transmit a use situation request signal to all the power feeding cases 6 via the power feeding router 5.

In each of the power feeding cases 6, if the power feeding controller 6a receives a use situation request signal, which is sent from the power feeding control apparatus 4, via the power feeding router 5 by means of the power receiver 6b, the power feeding controller 6a discriminates a use situation at that time (C1). After the power feeding controller 6a discriminates the use situation at that time, the power feeding controller 6a allows the power receiver 6b to transmit a use situation response signal, which signifies the discriminated use situation, to the power feeding control apparatus 4 via the power feeding router 5. Specifically, if the power feeding case 6 is accommodating the portable apparatus 3 at that time and is wirelessly feeding power to the accommodating portable apparatus 3, the power feeding controller 6a allows the power receiver 6b to transmit the use situation response signal, which signifies that power is being wirelessly fed to the portable apparatus 3, to the power feeding control apparatus 4. In contrast, if the power feeding case 6 does not accommodate the portable apparatus 3 at that time and is not wirelessly feeding power to the portable apparatus 3, the power feeding controller 6a allows the power receiver 6b to transmit the use situation response signal, which signifies that power is not wirelessly fed to the portable apparatus 3, to the power feeding control apparatus 4.

In the power feeding control apparatus 4, if the controller 4a receives a use situation response signal, which is sent from the power feeding case 6, via the power feeding router 5 by means of the power transmitter 4f, the controller 4a extracts a use situation from the received use situation response signal, analyzes the use situation (B2), and creates a response to a power feeding request (B3). In this case, the controller 4a creates as the response to the power feeding request a decision on whether power can be wirelessly fed from each of the power feeding cases 6, the specifications for a power feeding method, information on an amount of used power, or the like. The controller 4a then allows the wide range wireless communicator 4b to transmit a power feeding request response signal, which contains the created response to the power feeding request, to the portable apparatus 3 over the wide area communication network 9.

In the portable apparatus 3, if the controller 3a receives a power feeding request response signal, which is sent from the power feeding control apparatus 4, over the wide area communication network 9 by means of the wide range wireless communicator 4b, the controller 3a extracts a response to a power feeding request from the received power feeding request response signal, and allows the display device 3g to display the response (A2).

By performing the foregoing processing sequence, if the remaining capacity of the battery 31 of the portable apparatus 3 which a user uses decreases to a predetermined value, the user who uses the portable apparatus 3 can grasp information concerning wireless power feeding such as a decision on whether power can be wirelessly fed from each of the power feeding cases 6, the specifications for a power feeding method, or an amount of used power. Specifically, the user who uses the portable apparatus 3 can grasp whether any of the power feeding cases 6 is available (any of the power feeding cases 6 can wirelessly feed power) before the user rides in a vehicle in which the vehicle-side wireless power feeding system 2 is installed. The user can grasp whether power can be wirelessly fed to the portable apparatus 3 when the user rides in the vehicle.

(2) Processing of notifying a power feeding case, which can wirelessly feed power, to be performed by the vehicle-side wireless power feeding system 2

In the portable apparatus 3, the controller 3a regularly monitors whether the near distance wireless communicator 3c exists within a communication zone for near distance wireless communication. When a user carrying the portable apparatus 3 with her/him approaches a vehicle so as to ride in the vehicle or rides in the vehicle, if the controller 3a decides that the near distance wireless communicator 3c exists within the communication zone for near distance wireless communication (A11: Yes), the controller 3a allows the near distance wireless communicator 3c to transmit an authentication request signal to the power feeding control apparatus 4. Even in this case, if the user who uses the portable apparatus 3 preliminarily registers information on a transmission destination of the authentication request signal (address on a network or the like) in the portable apparatus 3, the controller 3a can transmit the authentication request signal to the power feeding control apparatus 4 which the user has registered in advance. The authentication request signal to be sent from the portable apparatus 3 to the power feeding control apparatus 4 contains authentication information that is necessary to authenticate the portable apparatus 3 to which wireless power feeding can be permitted to be made. Specifically, assuming that a condition for power feeding is met, for example, a wireless power feeding method is acceptable, and a result of authentication is Authenticated, wireless power feeding to be made from the power feeding case 6 to the portable apparatus 3 is permitted. In contrast, assuming that the condition for power feeding is not met, for example, the wireless power feeding method is unacceptable, and the result of authentication is Unauthenticated, wireless power feeding to be made from the power feeding case 6 to the portable apparatus 3 is inhibited.

In the power feeding control apparatus 4, if the controller 4a receives an authentication request signal, which is sent from the portable apparatus 3, by means of the near distance wireless communicator 4c, the controller 4a extracts authentication information from the received authentication request signal, and authenticates the portable apparatus (B11). When the controller 4a completes authentication, the controller 4a creates a result of authentication (B12). If the result of authentication is Authenticated, the controller 4a allows the near distance wireless communicator 4c to transmit an authentication response signal, which signifies that the result of authentication is Authenticated, to the power feeding control apparatus 4. In contrast, if the result of authentication is Unauthenticated, the power feeding controller 6a allows the near distance wireless communicator 4c to transmit the authentication response signal, which signifies that the result of authentication is Unauthenticated, to the power feeding control apparatus 4.

In the portable apparatus 3, if the controller 3a receives an authentication response signal, which is sent from the power feeding control apparatus 4, by means of the near distance wireless communicator 3c, the controller 3a extracts a result of authentication from the received authentication response signal, and makes a decision. If the controller 3a decides that the result of authentication is Authenticated (A12: Yes), the controller 3a allows the near distance wireless communicator 3c to transmit a position identification signal, which contains position information representing the position of the portable apparatus 3 specified by the position identifier 3i at that time, to the power feeding control apparatus 4.

In the power feeding control apparatus 4, if the controller 4a receives a position identification signal, which is sent from the portable apparatus 3, by means of the near distance wireless communicator 4c, the controller 4a extracts position information from the received position identification signal and identifies the position of the portable apparatus 3 (B13). Thereafter, the controller 4a identifies the position of a user in a vehicle compartment on the basis of seating sense signals which are inputted from the seating sensors 12 to the vehicle LAN connector 4g over the vehicle LAN 11 (B14).

The controller 4a identifies the position of a user, that is, the seat on which the user who carries with him/her the portable apparatus 3 that is needed to have power wirelessly fed to is seated, and recognizes the power feeding case 6 that is an object of notification (B15). Specifically, if the controller 4a decides based on a position identification signal that the portable apparatus 3 exists within a vehicle compartment and decides based on seating sense signals that the user has been seated on the driver seat, the controller 4a recognizes the power feeding case 6, which is located within reach of a driver seated on the driver seat, as the object of notification. More particularly, in the case of the layout shown in FIG. 2, since the power feeding cases 6 disposed, for example, on the internal flank 21 of the driver seat door 21, on the back surface 25a of the center console 25, and on the ceiling 27 of the vehicle compartment above the driver seat are the power feeding cases 6 located within reach of the driver seated on the driver seat, the controller 4a recognizes the power feeding cases 6 as objects of notification.

If the controller 4a decides based on a position identification signal that the portable apparatus 3 exists within a vehicle compartment and decides based on seating sense signals that a user has been seated on a rear seat, the controller 4a recognizes as an object of notifying the power feeding case 6 located within reach of an occupant seated on the rear seat. More particularly, in the case of the layout shown in FIG. 2, since the power feeding cases 6 disposed on the back surface 23a of the driver seat 23, on the back surface 24a of the passenger seat 24, and on the back surface 25a of the center console 25 are the power feeding cases 6 located within reach of the occupant seated on the rear seat, the controller 4a recognizes the power feeding cases 6 as objects of notification. After the controller 4a recognizes the power feeding cases 6 that are the objects of notification, the controller 4a allows the power transmitter 4f to transmit a notification driving signal to the recognized power feeding cases 6, which are the objects of notification, via the power feeding router 5. Even when plural users ride in a vehicle, if a user who carries the portable apparatus 3 that is needed to have power wirelessly fed manipulates the portable apparatus 3 so as to enter a seat on which the user has been seated, the controller 4a can discriminate the seat on which the user who carries with him/her the portable apparatus 3 that is needed to have power wirelessly fed is seated.

In the power feeding case 6, if the power feeding controller 6a receives a notification driving signal, which is sent from the power feeding control apparatus 4, via the power feeding router 5 by means of the power receiver 6b, the power feeding controller 6a allows the display device 6d or audio output device 6e to perform a notification action of notifying a position at which power can be fed (C11). More particularly, the power feeding controller 6a allows the display device 6d to indicate a predetermined indication pattern or allows the audio output device 6e to output a predetermined audio pattern. Assuming that the power feeding case 6 is the lid member inclusive power feeding case 31, the power feeding controller 6a lights or flickers the three LEDs 39a to 39c according to a predetermined lighting or flickering pattern. Assuming that the power feeding case 6 is the locking power feeding case 51, the power feeding controller 6a lights or flickers the three LEDs 60a to 60c according to the predetermined lighting or flickering pattern. If the controller 4a recognizes the power feeding cases 6 that are objects of notification, the controller 4a allows the near distance wireless communicator 4c to transmit a notification instruction signal, which contains notification recognition information signifying the power feeding cases 6 recognized as the objects of notification, to the portable apparatus 3.

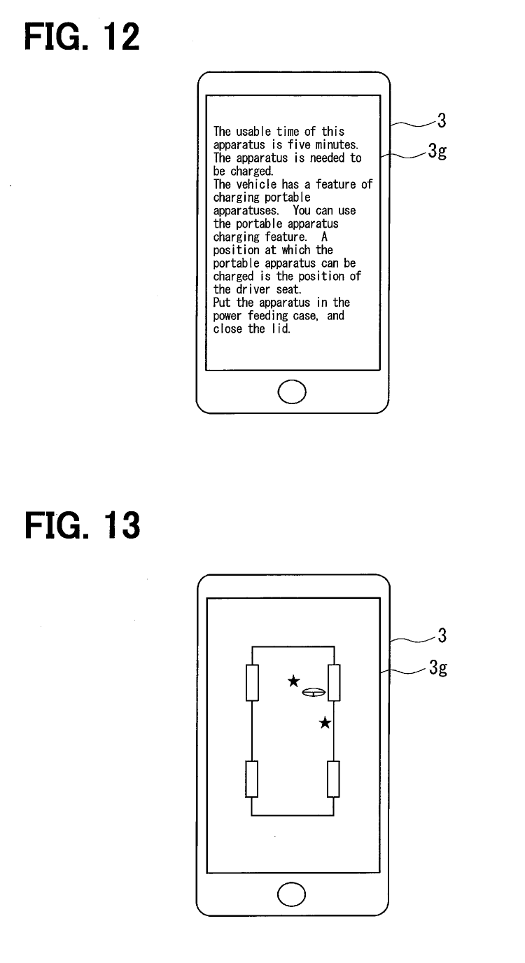

In the portable apparatus 3, if the controller 3a receives a notification instruction signal, which is sent from the power feeding control apparatus 4, by means of the near distance wireless communicator 3c, the controller 3a extracts notification recognition information from the received notification instruction signal and identifies the power feeding cases 6 recognized as objects of notification (A13). The controller 3a then allows the display device 3g to display position information representing the positions of the identified power feeding cases 6 that can wirelessly feed power (A14). More particularly, the controller 3a allows the display device 3g to display a display screen image signifying, as shown in FIG. 12, that the portable apparatus 3 is needed to be charged, that the portable apparatus 3 can be charged, and the positions of the power feeding cases 6 capable of wirelessly feeding power.

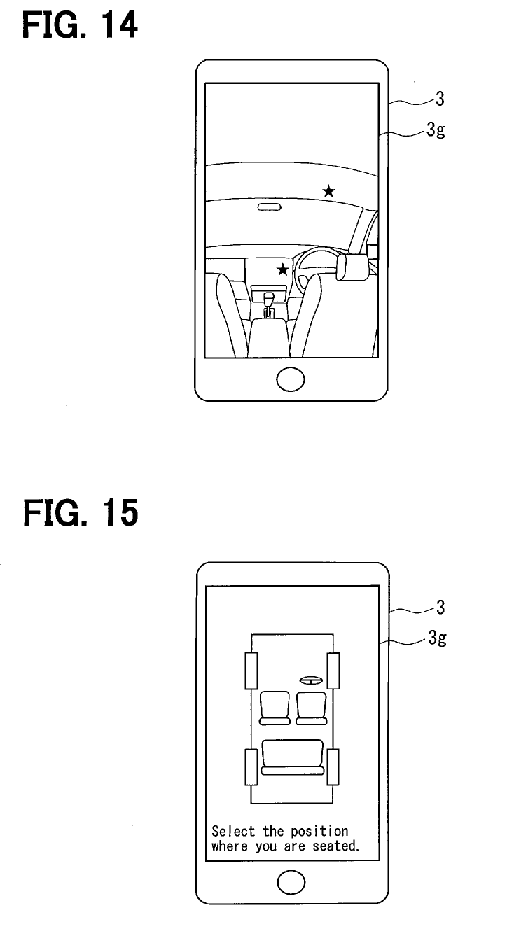

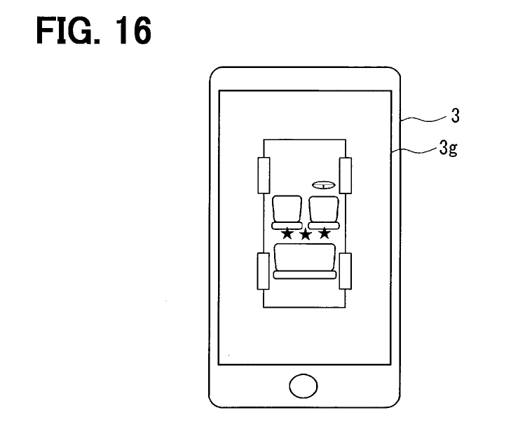

The controller 3a may allow the display device 3g to display a display screen image indicating, as shown in FIG. 13, only the positions of the power feeding cases 6 capable of wirelessly feeding power. FIG. 13 shows the display screen image indicating the positions of the power feeding cases 6 disposed, for example, on the internal flank 21a of the driver seat door 21 and on the face 26a of the instrument panel 26 respectively. For example, if the portable apparatus 3 includes a camera and has an imaging feature, the controller 3a may allow the display device 3g to display a display screen image in which the positions of the power feeding cases 6 capable of wirelessly feeding power are, as shown in FIG. 14, superposed on a photographic image produced by the camera. FIG. 14 shows the display screen image indicating the positions of the power feeding cases 6 disposed, for example, on the face 26a of the instrument panel 26 and on the ceiling 27 of a vehicle compartment above the driver seat respectively. Further, as shown in FIG. 15 and FIG. 16, if a user designates a seat, the controller 3a may allow the display device 3g to display a display screen image indicating the positions of the power feeding cases 6 that can wirelessly feed power and are located near the user-designated seat. FIG. 15 and FIG. 15 show a display screen image through which a user designates a rear seat, and a display screen image indicating the positions of the power feeding cases 6 disposed on the back surface 23a of the driver seat 23, on the back surface 24a of the passenger seat 24, and on the back surface 25a of the center console 25. Marks representing the positions of the power feeding cases 6 may be any ones.

By performing the foregoing processing sequence, as soon as a user who uses the portable apparatus 3 rides in a vehicle, the user can grasp the positions of the power feeding cases 6 that can feed power and are located within reach of the user. In other words, even if the user who uses the portable apparatus 3 does not look at the display screen of the portable apparatus 3, since the power feeding cases 6g capable of feeding power perform a notification action, the user can grasp the positions of the power feeding cases 6 capable of feeding power. Further, the user who uses the portable apparatus 3 can grasp the positions of the power feeding cases 6, which can feed power, by looking at the display screen of the portable apparatus 3.

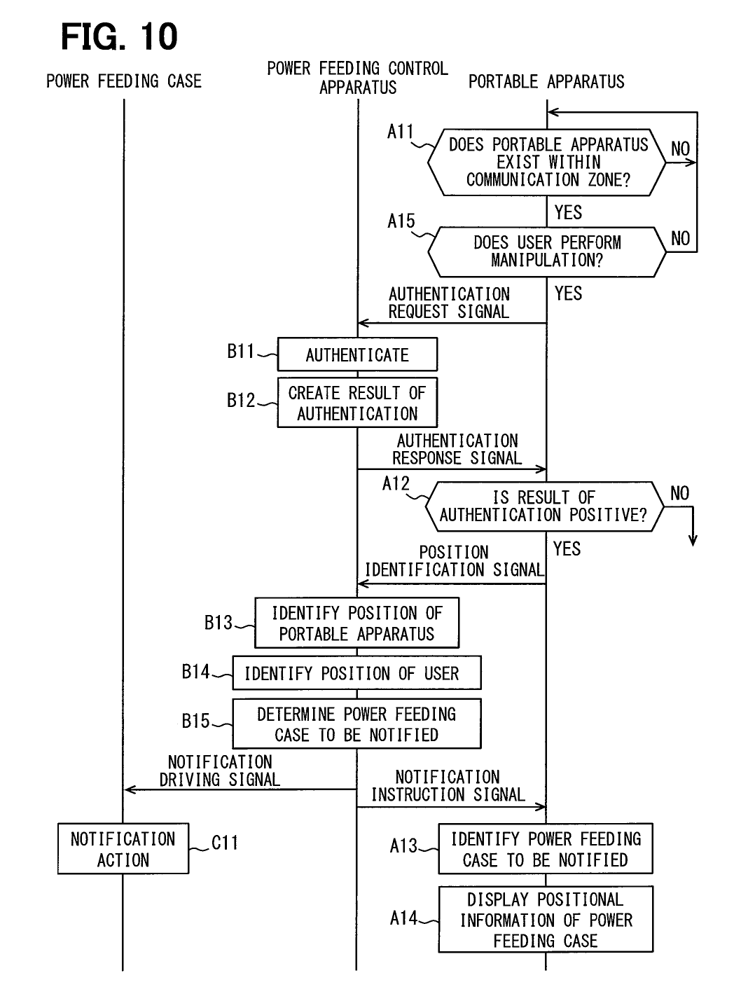

As mentioned in FIG. 10, after the controller 3a decides that the near distance wireless communicator 3c exists within a communication zone for near distance wireless communication (A11: Yes), the controller 3a decides whether a user has performed a predetermined manipulation (A15). If the controller 3a decides that the user has performed the predetermined manipulation (A15: Yes), the controller 3a may allow the near distance wireless communicator 3c to transmit an authentication request signal to the power feeding control apparatus 4, and may then perform subsequent processing.

(3) Processing of wirelessly feeding power to the portable apparatus 3 to be performed by the power feeding case 6

In the power feeding case 6, the power feeding controller 6a regularly monitors whether conditions for power feeding initiation have been met. If the power feeding controller 6a decides that the conditions for power feeding initiation have been met (C21: Yes), the power feeding controller 6a allows the wireless power feeder 6c to transmit a power receivable-or-not request signal to the portable apparatus 3. Assuming that the power feeding case 6 is the lid member inclusive power feeding case 31, if the lid member 33 is turned from the open position to the closed position with the portable apparatus 3 stowed in the stowage space 37 and contactless communication is established between the power feeding controller 6a and electronic tag 6f, the power feeding controller 6a decides that the conditions for power feeding initiation have been met. Assuming that the power feeding case 6 is the locking power feeding case 51, if the movable member 53 is turned from the unfixed position to the fixed position with the portable apparatus 3 stowed in the stowage space 59, the lock member 56 is turned from the unlocked position to the locked position so that the movable member 53 can be secured at the fixed position, and contactless communication is established between the power feeding controller 6a and electronic tag 6f, the power feeding controller 6a decides that the conditions for power feeding initiation have been met.

In the portable apparatus 3, if the controller 3a receives a power receivable-or-not request signal, which is sent from the power feeding case 6, by means of the wireless power receiver 3j, the controller 3a decides whether power can be received at that time (A21). If the portable apparatus 3 stands by to receive power at that time (for example, the battery 31 is normal) and can receive power, the controller 3a allows the wireless power receiver 3g to transmit a power receivable-or-not response signal, which signifies that power can be received, to the power feeding case 6. In contrast, if the portable apparatus 3 does not stand by to receive power at that time (for example, the battery 31 is not normal), and cannot receive power at that time, the controller 3a allows the wireless power receiver 3g to transmit a power receivable-or-not response signal, which signifies that power cannot be received, to the power feeding case 6.

In the power feeding case 6, if the power feeding controller 6a receives a power receivable-or-not response signal sent from the portable apparatus 3, the power feeding controller 6a decides based on the received power receivable-or-not response signal whether power can be received. If the power feeding controller 6a decides that the portable apparatus 3 can receive power (C22: Yes), the power feeding controller 6a allows the wireless power feeder 6c to transmit a power receiving preparation request signal to the portable apparatus 3.

In the portable apparatus 3, if the controller 3a receives a power receiving preparation request signal, which is sent from the power feeding case 6, by means of the wireless power receiver 3j, the controller 3a prepares for power receiving (A22). If the controller 3a completes preparations for power receiving, the controller 3a allows the wireless power receiver 3g to transmit a power receiving preparation response signal to the power feeding case 6.

In the power feeding case 6, if the power feeding controller 6a receives a power receiving preparation response signal sent from the portable apparatus 3, the power feeding controller 6a initiates wireless power feeding to be made from the wireless power feeder 6c to the wireless power receiver 3j of the portable apparatus 3 (C23 and A23). When the power feeding controller 6a thus initiates wireless power feeding, the power feeding controller 6a allows the wireless power feeder 6c to transmit a receiving state request signal to the portable apparatus 3. In this case, the power feeding controller 6a may allow the display device 6d or audio output device 6e to perform a notification action of notification the fact that wireless power feeding to be made from the wireless power feeder 6c to the wireless power receiver 3j of the portable apparatus 3 has been initiated.

In the portable apparatus 3, if the controller 3a receives a power receiving state request signal, which is sent from the power feeding case 6, by means of the wireless power receiver 3j, the controller 3a discriminates a power receiving state (A24), and allows the wireless power receiver 3g to transmit a power receiving state response signal containing the discriminated power receiving state.

In the power feeding case 6, if the power feeding controller 6a receives a power receiving state response signal sent from the portable apparatus 3, the power feeding controller 6a extracts a power receiving state from the power receiving state response signal, analyzes the power receiving state, and decides whether wireless power feeding made to the portable apparatus 3 is normal (C24). The power feeding controller 6a repeatedly transmits a power receiving state request signal to the portable apparatus 3 regularly at intervals of a predetermined cycle, and thus monitors wireless power feeding made to the portable apparatus 3. During a period in which power is wirelessly fed from the wireless power feeder 6c to the wireless power receiver 3j, the power feeding controller 6a uses the display device 6d or audio output device 6e to perform a notification action of notification pieces of information on a state of wireless power feeding, for example, an amount of fed power, a power feeding time, a charged capacity relative to a full capacity of the battery 31, and whether the state of wireless power feeding is normal or abnormal. More particularly, the power feeding controller 6a may allow the display device 6d to indicate any of predetermined indication patterns representing the respective pieces of information or may allow the audio output device 6e to output any of predetermined audio patterns. Assuming that the power feeding case 6 is the lid member inclusive power feed case 31, the power feeding controller 6a lights or flickers the three LEDs 39a to 39c according to any of predetermined lighting or flickering patterns. Assuming that the power feeding case 6 is the locking power feed case 51, the power feeding controller 6a lights or flickers the three LEDs 60a to 60c according to any of the predetermined lighting or flickering patterns.

During a period in which power is wirelessly fed from the wireless power feeder 6c to the wireless power receiver 3j, the power feeding controller 6a controls an amount of power, which is wirelessly fed from the wireless power feeder 6c to the wireless power receiver 3j, according to, for example, the power consumption required by equipment mounted in a vehicle. Namely, for example, the power feeding control apparatus 4 may acquire the power consumptions, which are required by respective electronic control units (ECUs) and other onboard devices, over the vehicle LAN 11, and the power feeding controller 6a may control the amount of power, which is wirelessly fed from the wireless power feeder 6c to the wireless power receiver 3j, according to the power consumptions acquired by the power feeding control apparatus 4.

The power feeding controller 6a monitors whether a condition for power feed termination has been met. If the power feeding controller 6a decides that the condition for power feeding termination has been met (C25: Yes), for example, if an amount of power fed to the portable apparatus 3 has reached a predetermined quantity, a power feeding time has reached a predetermined time, or a charged capacity relative to a full capacity of the battery 31 has reached a predetermined capacity, the power feeding controller 6a terminates wireless power feeding made from the wireless power feeder 6c to the wireless power receiver 3j of the portable apparatus 3 (C26 and A25). In this case, the power feeding controller 6a may allow the display device 6d or audio output device 6e to perform a notification action of notifying the fact that wireless power feeding made from the wireless power feeder 6c to the wireless power receiver 3j of the portable apparatus 3 has been terminated. By performing the foregoing processing sequence, once the portable apparatus 3 is stowed in the power feeding case 6, power can be wirelessly fed from the power feeding case 6 to the portable apparatus 3.

In this case, assuming that the power feeding case 6 is the lid member inclusive power feeding case 31, the portable apparatus 3 is surrounded by the shielding members 35 and 36 during a period in which the power feeding case 6 is wirelessly feeding power to the portable apparatus 3. Therefore, leakage of electromagnetic waves to outside, which is derived from wireless power feeding, can be hindered by the shielding members 35 and 36. In addition, assuming that the power feeding case 6 is the locking power feeding case 51, the portable apparatus 3 is surrounded by the shielding members during the period during which the power feeding case 6 is wirelessly feeding power to the portable apparatus 3. Therefore, leakage of electromagnetic waves to outside, which is derived from wireless power feeding, can be hindered by the shielding members.

As described so far, according to the present embodiment, the power feeding case 6 disposed in a vehicle compartment or the portable apparatus 3 which a user carries with him/her posts pieces of information on whether power can be wirelessly fed to the portable apparatus 3, an amount of power fed to the portable apparatus 3, a power feeding time, a charged capacity relative to a full capacity of the battery 31, and whether the state of wireless power feeding is normal or abnormal. Accordingly, various pieces of information concerning wireless power feeding to be made from the power feeding case 6 to the portable apparatus 3 can be presented to the user. This improves convenience.

The lid member inclusive power feeding case 31 includes the shielding members 35 and 36, and the portable apparatus 3 is surrounded by the shielding members 35 and 36 during a period in which power is wirelessly fed to the portable apparatus 3. Therefore, leakage of electromagnetic waves to outside, which is derived from wireless power feeding, can be hindered by the shielding members 35 and 36. Exposure to radiation will therefore not pose a problem. Even the locking power feeding case 51 includes the shielding members, and the portable apparatus 3 is surrounded by the shielding members during the period during which power is wirelessly fed to the portable apparatus 3. Therefore, leakage of electromagnetic waves to outside, which is derived from wireless power feeding, can be hindered by the shielding members. Exposure to radiation will not pose a problem.

An amount of power to be fed from the power feeding case 6 to the portable apparatus 3 can be controlled. Therefore, for example, if the amount of power to be fed from the power feeding case 6 to the portable apparatus 3 is controlled based on the power consumptions required by respective electronic control units and other onboard devices, an event that operating power for the other onboard devices cannot be preserved because of wireless power feeding made from the power feeding case 6 to the portable apparatus 3 can be avoided.

(Modifications)

The present disclosure is not limited to the aforesaid embodiment, but can be varied or expanded as mentioned below. Otherwise, plural variants may be combined.

A constituent feature that both the power feeding case and portable apparatus post various pieces of information concerning wireless power feeding has been described. Alternatively, either the power feeding case or portable apparatus may post various pieces of information concerning wireless power feeding. A display device that is mounted in a vehicle and includes, for example, a liquid crystal display or organic electroluminescent (EL) display may be connected to the power feeding case or power feeding control apparatus so that the display device can communicate with the power feeding case or power feeding control apparatus. Thus, the display device may display various pieces of information concerning wireless power feeding. In case the display device is adopted, for example, while a map for navigation is being displayed on the display device, various pieces of information concerning wireless power feeding may be displayed in an area that is part of the display screen. For example, a message signifying that power feeding will be initiated or power feeding will be terminated may be displayed in a pop-up window on the map.

The power feeding case that has both the indicator block and audio output block posted various pieces of information concerning wireless power feeding has been described so far. Alternatively, either the indicator block or audio output block may post various pieces of information concerning wireless power feeding.

As various pieces of information concerning wireless power feeding, information signifying whether a procedure of stowing a portable apparatus in a power feeding case is normal (for example, the vertical direction or front-back direction of the portable apparatus is normal) may be posted.

Even during a period in which a power feeding case is wirelessly feeding power to a portable apparatus, the portable apparatus and an onboard device mounted in a vehicle, for example, a navigation device may collaborate each other so as to provide any of various applications. For example, even during the period during which power is wirelessly fed to the portable apparatus, the portable apparatus and onboard device may be able to communicate data each other, and an application that enables music data, which is preserved in the portable apparatus, to be transferred from the portable apparatus to the onboard device, and enables the transferred music data to be outputted through a loudspeaker accompanying the onboard device may be provided.

If plural power feeding cases wirelessly feed power to respective portable apparatuses, priorities may be assigned to the power feeding cases in order to avoid concentration of power consumptions. Thus, the plural power feeding cases may sequentially initiate wireless power feeding according to the priorities.

1. A vehicular wireless power feeding system comprising:
a portable apparatus that includes a battery and operates using power, which is stored in the battery, as operating power;
a vehicle-side wireless power feeding system that is mounted to a vehicle, and includes a wireless power feeder for performing wireless power feeding to a wireless power receiver of the portable apparatus; and
a notifier that notifies of, as wireless power feeding information, information related to the wireless power feeding from the wireless power feeder to the wireless power receiver,
wherein the notifier includes a display unit of the portable apparatus or a display device mounted to a vehicle, and notifies of, as the wireless power feeding information, a position of the wireless power feeder.

2. The vehicular wireless power feeding system according to claim 1,
wherein the notifier notifies of, as the wireless power feeding information, information indicating whether the wireless power feeder enables the wireless power feeding to the wireless power receiver.

3. The vehicular wireless power feeding system according to claim 1,
wherein the notifier notifies of, as the wireless power feeding information, information on electric energy wirelessly fed from the wireless power feeder to the wireless power receiver.

4. The vehicular wireless power feeding system according to claim 1, wherein:
a charging capacity of the battery in the portable apparatus changes when the wireless power feeder performs the wireless power feeding to the wireless power receiver; and
the notifier notifies of, as the wireless power feeding information, information on the charging capacity of the battery that is changed by the wireless power feeding from the wireless power feeder to the wireless power receiver.

5. The vehicular wireless power feeding system according to claim 1,
wherein the notifier notifies of, as the wireless power feeding information, information on whether the wireless power feeding from the wireless power feeder to the wireless power receiver is in a normal state or an abnormal state, when the wireless power feeder performs the wireless power feeding to the wireless power receiver.

6. The vehicular wireless power feeding system according to claim 1,
wherein the notifier is arranged in the vehicle-side wireless power feeding system.

7. (canceled)

8. The vehicular wireless power feeding system according to claim 1, wherein:
the wireless power feeder is arranged in a power feeding case, the power feeding case accommodating the portable apparatus; and
the wireless power feeding to the wireless power receiver is enabled when the power feeding case accommodates the portable apparatus.

9. The vehicular wireless power feeding system according to claim 8, wherein:
the wireless power feeder enables the wireless power feeding to the wireless power receiver when a predetermined condition is satisfied under a condition that the power feeding case accommodates the portable apparatus; and
the wireless power feeding to the wireless power receiver is not enabled when the predetermined condition is not satisfied even under a condition that the power feeding case accommodates the portable apparatus.

10. The vehicular wireless power feeding system according to claim 9,
wherein the wireless power feeder has the predetermined condition that enables suppressing leakage of an electromagnetic wave to outside through the wireless power feeding as the predetermined condition.

11. The vehicular wireless power feeding system according to claim 1,
wherein the wireless power feeder enables controlling of the electric energy feeding to the wireless power receiver.

12. A vehicle-side wireless power feeding system arranged in a vehicle, comprising:
a wireless power feeder that performs wireless power feeding to a wireless power receiver of a portable apparatus that operates using power, which is stored in a battery, as operating power; and
a notifier that notifies of, as wireless power feeding information, information related the wireless power feeding from the wireless power feeder to the wireless power receiver,
wherein the notifier includes a display unit of the portable apparatus or a display device mounted to a vehicle, and notifies of, as the wireless power feeding information, a position of the wireless power feeder.

13. A portable apparatus that operates using power, which is stored in a battery, as operating power, comprising:
a wireless power receiver to which wireless power feeding is performed by a wireless power feeder of a vehicle-side wireless power feeding system arranged in a vehicle; and
a notifier that notifies of, as wireless power feeding information, information related to wireless power feeding from the wireless power feeder to the wireless power receiver,
wherein the notifier includes a display unit of the portable apparatus or a display device mounted to a vehicle, and notifies of, as the wireless power feeding information, a position of the wireless power feeder.

14. The vehicular wireless power feeding system according to claim 1, wherein:
the wireless power feeder includes a plurality of wireless power feeder elements;
the plurality of wireless power feeder elements are mounted to the vehicle; and
the display unit of the portable apparatus or the display device notifies of, as the wireless power feeding information, a position of at least one of the plurality of wireless power feeder elements which enables the wireless power feeding.

15. The vehicular wireless power feeding system according to claim 1, comprising:
a seating sensor that detects a sitting position of a user, wherein:
the wireless power feeder includes a plurality of wireless power feeder elements;
the plurality of wireless power feeder elements are mounted to the vehicle; and
the display unit of the portable apparatus or the display device notifies of, as the wireless power feeding information, a position of at least one of the plurality of wireless power feeder elements which enables the wireless power feeding and is adjacent to the sitting position of the user detected by the seating sensor.
